(19) United States
(12) Patent Application Publication
(10) Pub. No.: US 2026/0019952 A1
(43) Pub. Date: Jan. 15, 2026

(54) POWER-DEPENDENT METASURFACE FOR SHIELDING IN-BAND HIGH-POWER ELECTROMAGNETIC SIGNALS

(71) Applicant: Dell Products L.P., Round Rock, TX (US)

(72) Inventors: Tejinder Singh, Manotick (CA); Navjot Kaur Khaira, Manotick (CA); Kan Wang, Ottawa (CA)

(21) Appl. No.: 18/768,630

(22) Filed: Jul. 10, 2024

(51) Int. Cl. H04W 52/02

(52) U.S. Cl. CPC H04W 52/0274

(57) ABSTRACT

The technology described herein is directed towards a metasurface for protection against high power electromagnetic (EM)/radio frequency signals, including at high frequencies. The metasurface unit cell design is based on using metal-insulator transition material (e.g., VO₂) patch elements, which can be monolithically integrated during fabrication. At lower power levels, the VO₂ patch elements are in a high resistance state, allowing inner and outer metal portions of a unit cell to resonate at a desired incoming frequency, thereby passing the signals through the metasurface. At a high power threshold level, determined by dimensions of the VO₂ patch elements, the VO₂ patch elements are in a low resistance state that couples the inner and outer metal portions into a single low resistance conductive surface that shields the signals from passing through the metasurface. The metal-insulator transition material metasurface operates passively, and provides rapid-response shielding against sudden high-power EM exposure.

### BACKGROUND

In multiple-input and multiple-output (MIMO)/receiver architectures for radio frequency (RF) communications, high power electromagnetic signals (EM) signals can disrupt, degrade, or destroy the sensitive devices in the RF chain, such as low noise amplifiers. When high-energy EM signals impinge on the receiver, the induced high current may cause malfunction of the power-sensitive devices. The conventional method to deal with this problem is to use an absorber to reduce the power of an impinging signal to an acceptable level; however, absorbers provide fixed attenuation to the signal even when the signal is within the desired power range. Using a normal frequency selective surface, or a filter to block out the EM signals at frequencies out of the operating band is only partially useful, because any high-power signals within the operating frequency range can still heavily damage the system.

### BRIEF DESCRIPTION OF THE DRAWINGS

The technology described herein is illustrated by way of example and not limited in the accompanying figures in which like reference numerals indicate similar elements and in which:

FIG. 1 is a representation of an example radio frequency (RF) protection metasurface that passes low power signals within a defined frequency band, in accordance with various example embodiments and implementations of the subject disclosure.

FIG. 2 is a representation of the example radio frequency (RF) protection metasurface preventing high power signals from passing, including those signals within the defined frequency band, in accordance with various example embodiments and implementations of the subject disclosure.

FIG. 3 is a representation of the example radio frequency (RF) protection metasurface, showing various elements and dimensions of a metal-insulator transition material that determine the threshold high-power level, in accordance with various example embodiments and implementations of the subject disclosure.

FIG. 4 is a top view representation of the example unit cell described herein illustrating that in the low power state, the switches (metal-insulator transition material) are equivalent to capacitors, forming a resonating structure, whereas in the high-power state, the switches are equivalent to small resistors, in accordance with various example embodiments and implementations of the subject disclosure.

FIG. 5 is a three-dimensional view representation of an example unit cell model used in simulations, in accordance with various example embodiments and implementations of the subject disclosure.

FIG. 6 is a graphical representation of meshing the example structure (unit cell model) for use in finite element analysis, in accordance with various example embodiments and implementations of the subject disclosure.

FIG. 7 is a graphical representation of example resulting S-parameters simulated based on the unit cell geometry of FIG. 5, in accordance with various example embodiments and implementations of the subject disclosure.

FIG. 8 is a graphical representation of the example frequency response of the unit cell simulated at 28 gigahertz (GHz), in accordance with various example embodiments and implementations of the subject disclosure.

FIG. 9 is a graphical representation of the example frequency response of the unit cell simulated at 67 gigahertz (GHz), in accordance with various example embodiments and implementations of the subject disclosure.

FIG. 10 is a graphical representation of power overflow protection based on various example designs for different input power levels, in accordance with various example embodiments and implementations of the subject disclosure.

### DETAILED DESCRIPTION

The technology described herein is generally directed towards a radio frequency (RF) protection metasurface that can provide a passband for low-power electromagnetic (EM) signals, and a stopband for high-power EM signals. In one implementation, the RF protection metasurface includes a power-dependent metal-insulator transition material that acts as a self-actuating and self-de-actuating switch. The metasurface thus operates as a frequency selective surface that can selectively block the in-band high-power signals while letting the low power signals pass through, without any attenuation.

In one implementation design, the metal-insulator transition material includes vanadium dioxide (VO₂)-based tunable patch elements that self-switch after a threshold power level, depending on the dimensions of the patch. The switch design has an exceptionally fast response time, on the order of picoseconds, and is passive, meaning the switch operates without the need for external power. Note that the metal-insulator transition material design described herein is in contrast to using diodes for protecting RF circuitry, as diodes cause signal distortion and are limited to low frequency applications.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

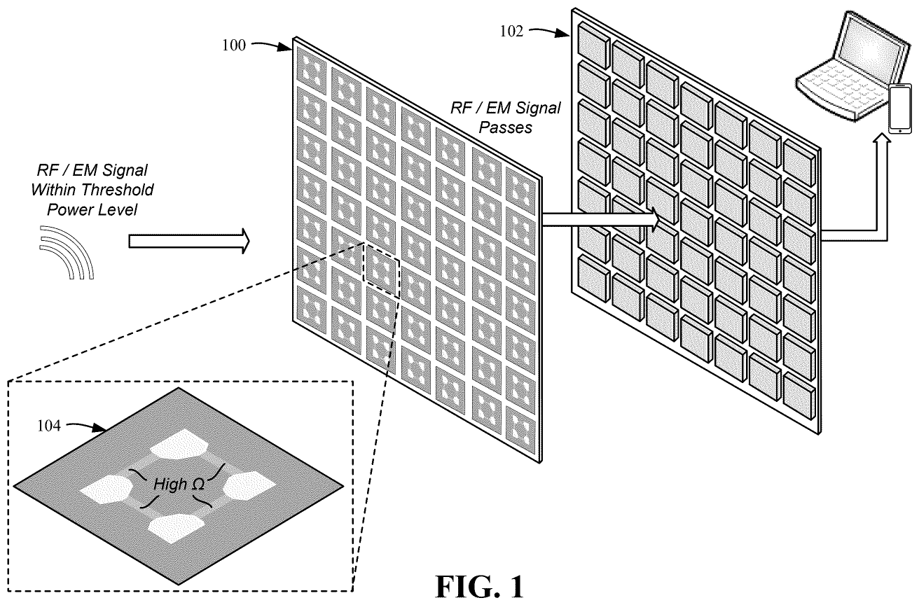

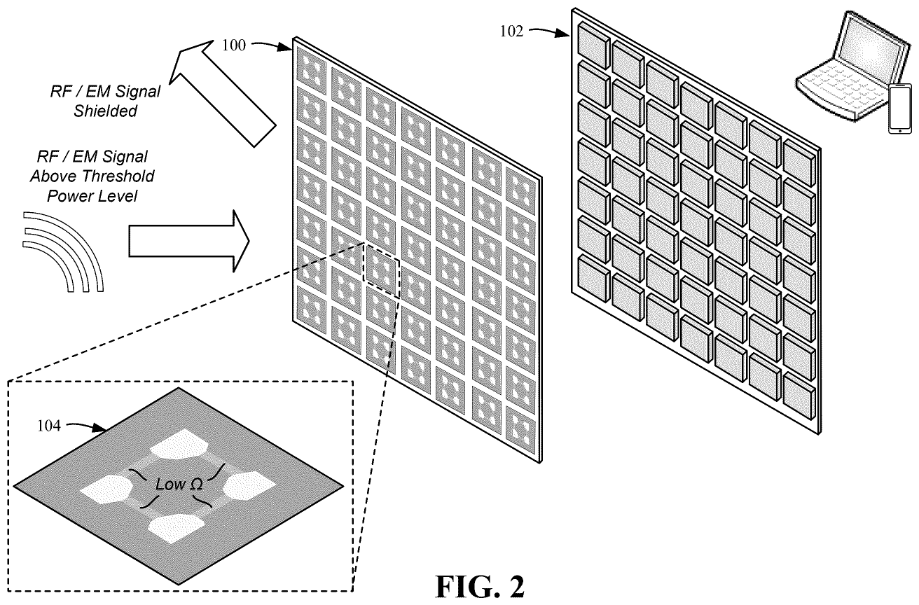

FIG. 1 is a representation of one example implementation of a power-sensitive RF protection metasurface (system) 100, which in this example is a passive, power-selective layer situated atop an antenna array 102; that is, the power-sensitive metasurface 100 is between a source of RF/EM signals and the RF-sensitive device/circuitry to protect. This configuration ensures that when the metasurface 100 is exposed to in-band signals beneath a predefined power threshold, the metasurface 100 permits passage of the signals, effectively behaving as an invisible barrier with respect to such lower power signals. Conversely, as shown in FIG. 2, signals that exceed this power threshold result in the metasurface transforming into a virtually impenetrable reflective barrier, akin to a metallic shield, thereby preventing high-power signal transmission through the metasurface 100.

As shown in the example configuration of the metasurface 100 loaded with VO₂ patches in FIGS. 1 and 2, one example implementation is based on a rectangular (square) slot design within the unit cells; one such unit cell 104 is shown enlarged relative to the metasurface 100. Note that this square slot design is a non-limiting example of one of many possible unit cell designs; the flexibility in design facilitates the adaptability of a power-sensitive metasurface to various operational needs and specifications, which can be applied to any application of a wide variety of applications.

In general, and as described herein, each of the unit cells act as a resonator that permits only EM signals within a specific frequency range to pass, as well serving as a power selector that only allows those EM signals below a predetermined power level to pass through. Consequently, the metasurface 100 described both filters out out-of-band signals while blocking any high-power EM signals, including those within the desired band. This is significant, as high power EM signals pose a danger to receiver antenna and other sensitive RF components on the RF chain for several reasons, including that high power EM signals can induce currents and voltages that exceed a device's designed operating parameters, which can result in immediate damage to the components. Even if not immediately damaging, high power EM signals can interfere with the normal operation of electronic devices by introducing noise and spurious signals. The absorption of high-power EM energy by electronic circuits can lead to rapid heating, potentially damaging components through thermal stress and, in extreme cases, leading to fires and explosions.

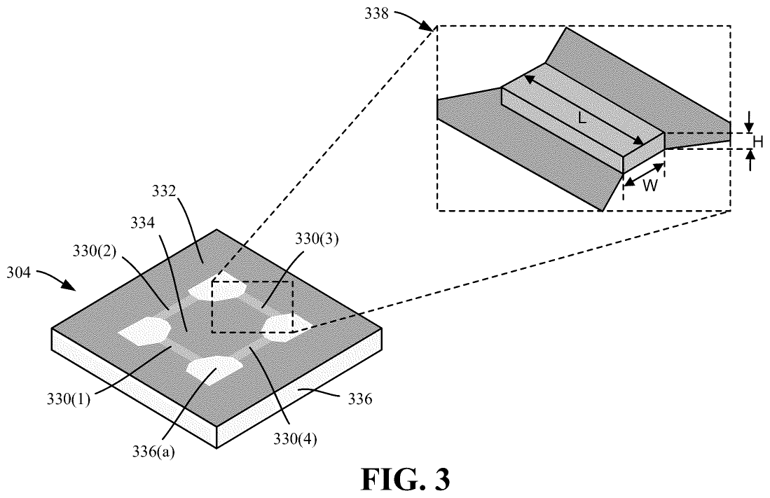

As described herein, one implementation employs a thin film VO₂ patch as the power dependent switchable element. As shown in FIG. 3, for a unit cell 304 with a rectangular slot design, a total of four such VO₂ elements 330(1)-330(4) are placed in the gap between the outer metal conductor 332 and the central metal 334. The top metallization layer that forms the outer metal conductor 332 and the central metal 334, and the VO₂ elements 330(1)-330(4), are supported by a substrate 336. Note that where there is neither metal nor VO₂ material, the substrate material is visible in FIG. 3, as depicted by the one labeled substrate portion 336(a).

VO₂ thin films exhibit the ability to switch between metallic and insulating phases in response to temperature changes. This characteristic enables the VO₂ patch elements 330(1)-330(4) to alternate between two states, namely a high resistance state and a low resistance state, through global heating applications. Significantly, VO₂ patches can undergo this phase transition autonomously under high RF power conditions, attributed to the heat generated within the patch itself. Thus, the VO₂ patch elements 330(1)-330(4) inherently function as self-activating switches when exposed to RF power levels surpassing a certain RF power threshold. Note that while such behavior might be deemed undesirable in conventional switch architectures, the use of VO₂/metal-insulator transition material patches in the unit cell device described herein is highly beneficial relative to other RF protection technologies.

Thus, in the high resistance state corresponding to the power of the incoming RF signals being below the threshold level, the VO₂ patch elements 330(1)-330(4) act as insulators, whereby the unit cells resonate at frequencies within the desired operational band, allowing the incoming RF signals to pass through (FIG. 1). When the power of the incoming RF signals reaches or exceed the threshold level, the VO₂ patch elements 330(1)-330(4) act as conductors, electrically coupling the outer metal conductor 332 and the central metal 334 together, whereby the unit cells do not resonate, including at frequencies within the desired operational band, basically (along with the ground plane of the metasurface) shielding/reflecting the incoming RF signals, preventing them from passing through (FIG. 2).

The RF power threshold of the VO₂ patch elements 330(1)-330(4) is determined by each patch's design length and width dimensions (L×W) and the VO₂ layer thickness H, as shown in FIG. 3 by the enlarged portion 338 of the unit cell 304. By adjusting these channel dimensions, a designer can fine-tune the device's power handling capabilities. The VO₂ patch's switching speed is very fast, clocking in at measured times on the order of picoseconds. Moreover, one of the advantages of a VO₂ patch is a large and high-frequency operational frequency range, ensuring desirable RF performance across a broad spectrum, from DC up to around 67 GHz.

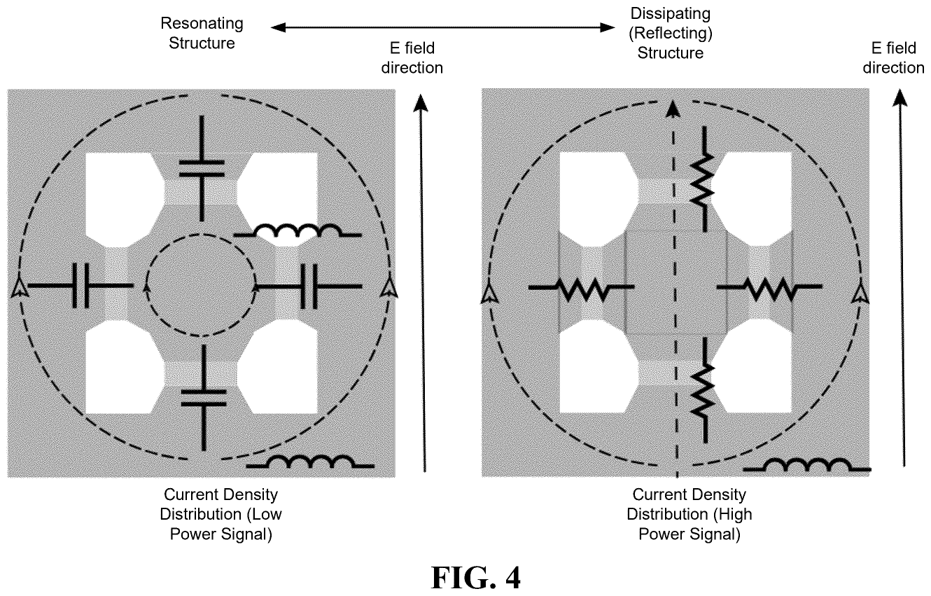

In general, and as represented in FIG. 4, for low power signals in the operational band, the VO₂ element acts like a capacitor. Conversely, for high power signals, the VO₂ element acts like a small resistor. Note that beyond the many advantages compared to diodes, unlike a diode-based design, which requires on-chip soldering of the diode components, the technology described herein can monolithically integrate the VO₂ patches during the fabrication process.

To summarize, to achieve the power dependent functionality, VO₂ patch elements are placed between the (e.g., square) slot's inner and outer conductors as shown in FIG. 3. In this model, the metasurface unit cell can be thought of as having two inductors, one of which represents the outer metal ring, and the other corresponding to the central square patch. A capacitor can represent the gap between these two metal sections. Thus, with the monolithic integration of VO₂ as a customizable switch, in the low power state, the switch is equivalent to capacitor, forming a resonating structure with the aperture as inductors. In the high-power state, the switch is equivalent to a small resistor, making the structure dissipative. In general, at lower power levels, the VO₂ patch elements behave essentially as an open circuit. Conversely, at higher power levels, each low resistance VO₂ patch element effectively becomes a short circuit; this change essentially creates a direct connection between the outer and inner metal parts, making the metasurface behave as if it were a single continuous metal sheet. As a result, the metasurface reflects high-power EM signals instead of allowing them to pass through.

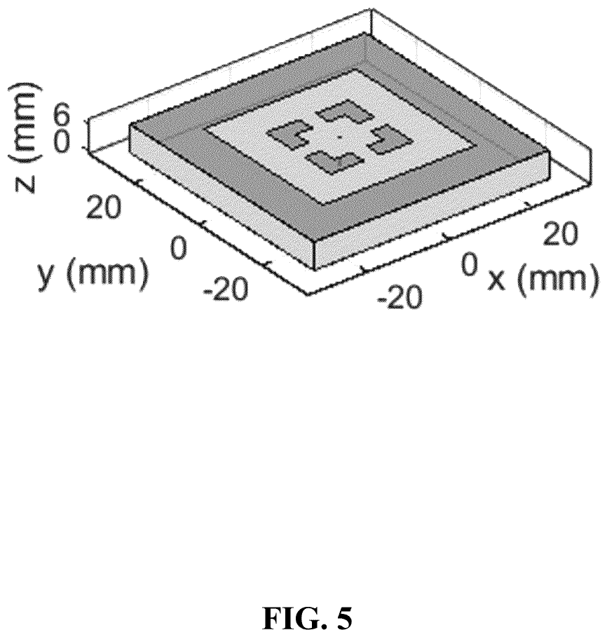

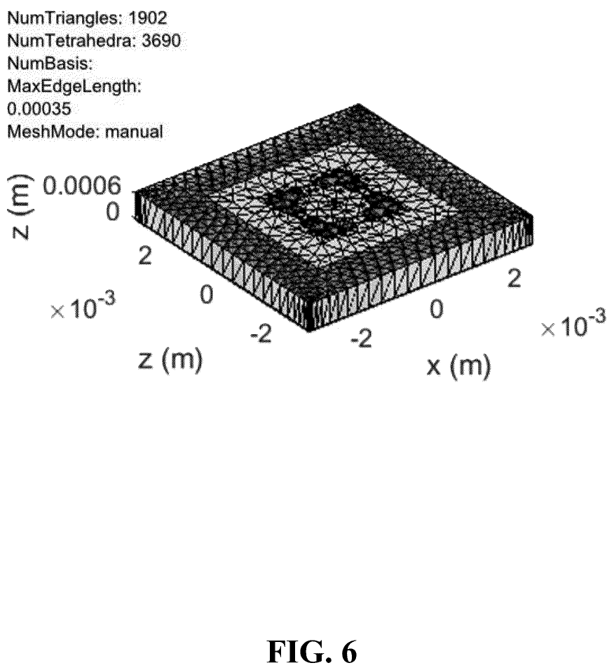

To simulate the structure in an EM simulation tool, at low power, the patch is represented like an insulator, and at high power levels, the patch is represented like a metallic conductor, providing the appropriate VO₂ resistivities from experimental data in both states. The EM simulation model along with example dimensions/geometry is shown in FIG. 5. Finite element analysis is carried out by meshing the entire structure, as shown in FIG. 6, with a resonating frequency around 6 GHz. Note that to examine the design's performance under various conditions, both circuit simulations and finite element model simulations were employed, assessing the metasurface's response to low and high incident EM powers. The simulations confirm a rapid reduction in received power after a threshold power level. Such a metasurface is thus able to provide a protection screen to shield receiver/electronic devices from high power EM signals. Further, because the metasurface is a planar surface, the metasurface provides several advantages in terms of practical installation on a receiver or any electronic device. Indeed, the metasurface can be laid on the receiver antennas or even in MIMO applications in a straightforward manner.

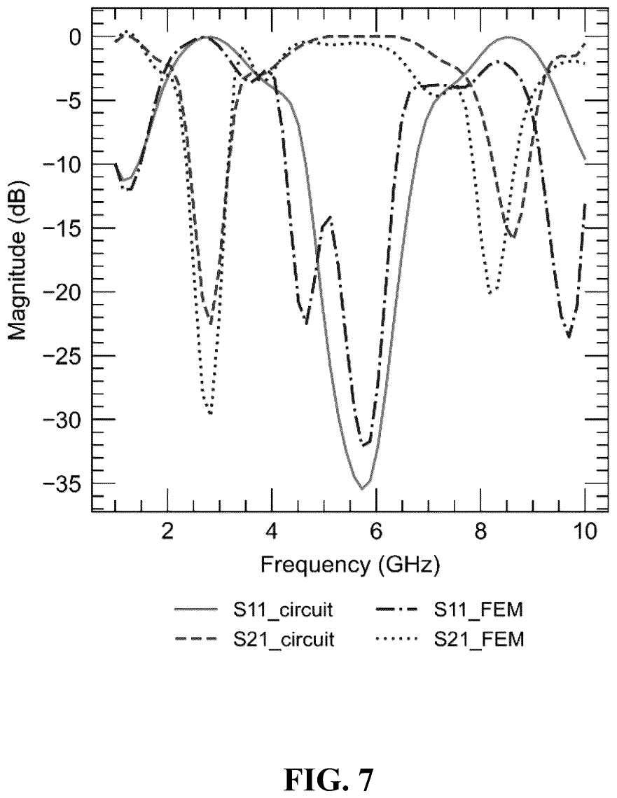

The EM simulation response along with the circuit simulation response is shown in the example graphical representation of FIG. 7, with a center frequency at 6 GHz. As can be seen, at low-power levels, S21≤−1 dB, and S11≥−35 dB, which means almost entire signal passes through, with very minimal amount of the signal reflecting back. The resulting S-parameters of the unit cell geometry show in the results that the unit cell design demonstrates frequency-selective behavior with a passband around 6 GHz; good agreement was observed between the approach of full-wave simulation with finite element method (FEM) and equivalent model.

The switching time of the VO₂ patch is in picoseconds, providing a very quick response against sudden high power EM signals exposure. A significant advantage of this configuration is the ability to tailor the dimensions of the VO₂ patches, making it possible to adjust the threshold power level according to specific needs.

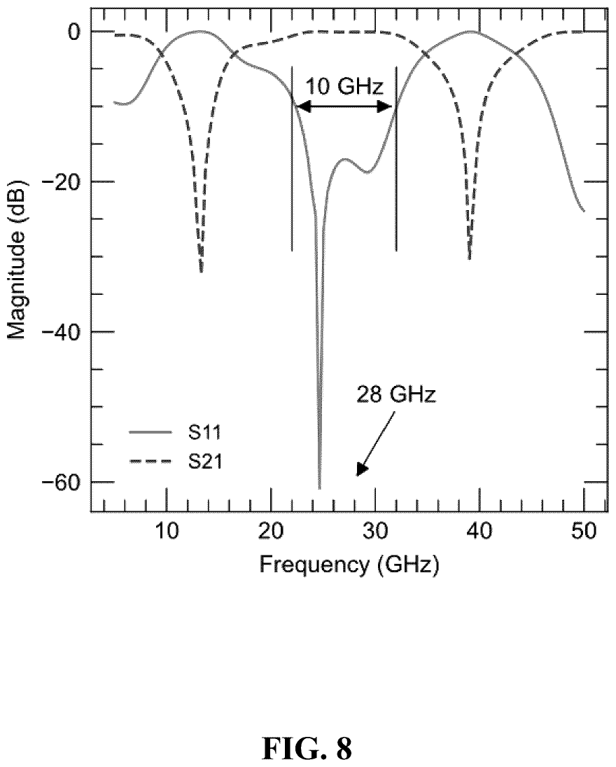

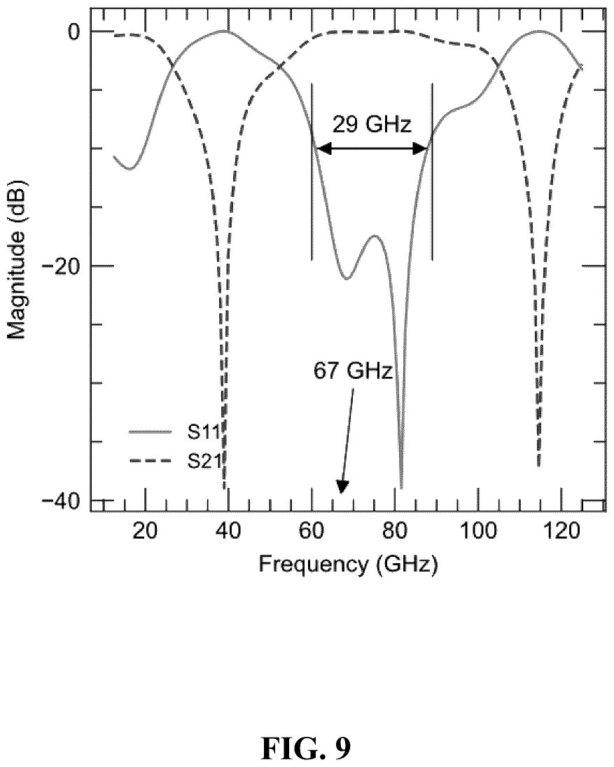

FIGS. 8 and 9 show the frequency response of the unit cell when the geometry and the VO₂ patch dimensions are tuned for operation at center frequencies 28 GHz and 67 GHz, respectively. Note that a VO₂-based switch was reported to have an operating frequency range of DC-67 GHz. The range demonstrated in FIGS. 8 and 9 highlight the scalability and flexibility of the design, making it desirable for a wide range of applications.

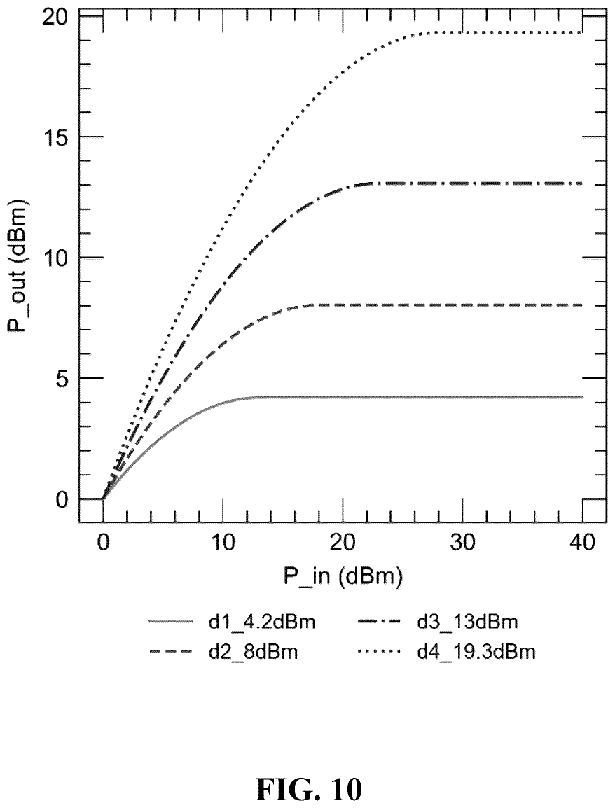

FIG. 10 highlights the input versus output power relationship of the designed protection circuit. Depending on the VO₂ patch dimensions and thickness, the output power can be limited at different power thresholds. Indeed, the circuit simulation results shown in FIG. 10 illustrate the input power overflow protection, by way of the relationship between output power and input power, showing examples of power limiter for 4.2 dBm, 8 dBm, 13 dBm, 19.3 dBm. FIG. 10 also shows the variation in transmission coefficient of the metasurface with increasing input power on a 20 dBm power limiter. The steepness of cutoff power is varied based on the aperture geometry.

One or more example embodiments can be embodied in a device, such as described and represented herein. The device can include a metasurface positioned between a source of incoming radio frequency signals and a radio frequency-sensitive device, the metasurface configured to protect the radio frequency-sensitive device. The metasurface can include a metal-insulator transition material that self-actuates in response to an input power of incoming radio frequency signals satisfying a defined threshold radio frequency high power level, resulting in redirecting the incoming radio frequency signals and foregoing coupling of the incoming radio frequency signals to the radio frequency-sensitive device, and self-de-actuates in response to the input power of the incoming radio frequency signals not satisfying the defined threshold radio frequency high power level, resulting in the coupling of the incoming radio frequency signals to the radio frequency-sensitive device.

The metal-insulator transition material can include vanadium dioxide.

The defined threshold radio frequency high power level can be based on at least one of: a length of the metal-insulator transition material, a width of the metal-insulator transition material, or a thickness of the metal-insulator transition material.

A switching time in which the metal-insulator transition material self-actuates can be less than one nanosecond.

The metal-insulator transition material can be part of a ring resonator that resonates at a resonating frequency corresponding to a frequency of the incoming radio frequency signals. The ring resonator can correspond to a specific frequency range to pass through to the radio frequency-sensitive device when the metal-insulator transition material self-de-actuates. The ring resonator can be formed as a rectangle having four sides, each side comprising a metal-insulator transition material portion that changes to a low resistance state when the metal-insulator transition material self-actuates, and changes to a high resistance state when the metal-insulator transition material self-de-actuates. The ring resonator can include a metallic inner portion, the metal-insulator transition material, and a metallic outer portion that can be fabricated as a single layer.

The radio frequency-sensitive device can include an antenna array.

One or more example embodiments can be embodied in a metasurface, such as described and represented herein. The metasurface can include a metallic ring resonator section, which can include a metallic inner portion and a metallic outer portion, and a metal-insulator transition material between the metallic inner portion and the metallic outer portion. The metal-insulator transition material can transition to a low resistance state in response to an incoming radio frequency signal satisfying a defined threshold radio frequency high power level, to electrically couple the metallic inner portion to the metallic outer portion, wherein, in the low resistance state, the metallic ring resonator section shields radio frequency sensitive circuitry from the incoming radio frequency signal. The metal-insulator transition material can transition to a high resistance state in response to the incoming radio frequency signal not satisfying a defined threshold radio frequency high power level, to electrically decouple the metallic inner portion from the metallic outer portion, wherein, in the high resistance state, the metallic ring resonator section passes the incoming radio frequency signal to the radio frequency sensitive circuitry.

The metallic ring resonator section can include a respective metallic ring resonator of an array of respective metallic ring resonators of the metasurface, and the respective metallic ring resonators can be configured to protect respective radio frequency sensitive devices of the radio frequency sensitive circuitry.

The defined threshold radio frequency high power level can be based on at least one of: a length of the metal-insulator transition material, a width of the metal-insulator transition material, or a thickness of the metal-insulator transition material.

The metallic ring resonator section can correspond to a specific frequency range to pass through to the radio frequency-sensitive device when the metal-insulator transition material is in the high resistance state.

The metal-insulator transition material can include vanadium dioxide.

The metallic inner portion can include four respective sides, and the metal-insulator transition material can include four respective patches adjacent to the four respective sides.

The metallic ring resonator section and the metal-insulator transition material can be fabricated as a single unit.

One or more example embodiments can be embodied in a system, such as described and represented herein. The system can include a metasurface that protects radio frequency circuitry from incoming electromagnetic waves that satisfy a defined threshold power level. The metasurface can include a metallic inner portion, a metallic outer portion, and a metal-insulator transition material that transitions to a low resistance state in response to the defined threshold power level being satisfied, and transitions to a high resistance state in response to the defined threshold power level not being satisfied. The metal-insulator transition material separates the metallic inner portion from the metallic inner portion, in which in the low resistance state, the metal-insulator transition material electrically couples the metallic inner portion to the metallic outer portion to prevent the incoming electromagnetic waves from passing through the metasurface to the radio frequency circuitry. In the high resistance state, the metal-insulator transition material electrically insulates the metallic inner portion from the metallic outer portion to allow the incoming electromagnetic waves to pass through the metasurface to the radio frequency circuitry.

The metasurface can correspond to a specific frequency range to pass through to the radio frequency-sensitive device when the metal-insulator transition material is in the high resistance state.

The metal-insulator transition material can include vanadium dioxide.

The metallic inner portion can include four respective inner sides, the metallic outer portion can include four respective outer sides, and the metal-insulator transition material can include four respective patches between the four respective inner sides and the four respective outer sides.

As can be seen, various implementations and embodiments of the technology described herein are directed to a metasurface for high power EM protection, including at high frequencies. The metasurface design, based on using metal-insulator transition material (e.g., VO₂) patch elements, which can be monolithically integrated during fabrication, effectively differentiates between signals based on their power level, blocking high-power signals, while overcoming the signal distortion/low frequency limit issues of diode-based designs, and without needing any soldered components. The passive metasurface design provides for customizable power thresholds and scalable frequency bands, via various dimensions and unit cell designs. The metasurface technology described herein facilitates precise design adjustments of the power threshold levels and operational frequency bands as needed. The metasurface operates passively, without external DC power, unlike diode-based systems which need constant power and a biasing network.

The metasurface provides rapid-response shielding against sudden high-power EM exposures with high-speed protection to protect from abrupt, high-power EM exposures. The VO₂ patches provide the ability to transition between metallic and insulator phases within the picosecond timeframe, thereby preventing damage to sensitive components against sudden electromagnetic disturbances.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A device, comprising:
a metasurface positioned between a source of incoming radio frequency signals and a radio frequency-sensitive device, the metasurface configured to protect the radio frequency-sensitive device, the metasurface comprising:
a metal-insulator transition material that:
self-actuates in response to an input power of incoming radio frequency signals satisfying a defined threshold radio frequency high power level, resulting in redirecting the incoming radio frequency signals and foregoing coupling of the incoming radio frequency signals to the radio frequency-sensitive device, and
self-de-actuates in response to the input power of the incoming radio frequency signals not satisfying the defined threshold radio frequency high power level, resulting in the coupling of the incoming radio frequency signals to the radio frequency-sensitive device.

2. The device of claim 1, wherein the metal-insulator transition material comprises vanadium dioxide.

3. The device of claim 1, wherein the defined threshold radio frequency high power level is based on at least one of: a length of the metal-insulator transition material, a width of the metal-insulator transition material, or a thickness of the metal-insulator transition material.

4. The device of claim 1, wherein a switching time in which the metal-insulator transition material self-actuates is less than one nanosecond.

5. The device of claim 1, wherein the metal-insulator transition material is part of a ring resonator that resonates at a resonating frequency corresponding to a frequency of the incoming radio frequency signals.

6. The device of claim 5, wherein the ring resonator corresponds to a specific frequency range to pass through to the radio frequency-sensitive device when the metal-insulator transition material self-de-actuates.

7. The device of claim 5, wherein the ring resonator is formed as a rectangle having four sides, each side comprising a metal-insulator transition material portion that changes to a low resistance state when the metal-insulator transition material self-actuates, and changes to a high resistance state when the metal-insulator transition material self-de-actuates.

8. The device of claim 5, wherein the ring resonator comprises a metallic inner portion, the metal-insulator transition material, and a metallic outer portion that are fabricated as a single layer.

9. The device of claim 1, wherein the radio frequency-sensitive device comprises an antenna array.

10. A metasurface, comprising:
a metallic ring resonator section comprising a metallic inner portion and a metallic outer portion; and
a metal-insulator transition material between the metallic inner portion and the metallic outer portion, wherein the metal-insulator transition material:
transitions to a low resistance state in response to an incoming radio frequency signal satisfying a defined threshold radio frequency high power level, to electrically couple the metallic inner portion to the metallic outer portion, wherein, in the low resistance state, the metallic ring resonator section shields radio frequency sensitive circuitry from the incoming radio frequency signal; and
transitions to a high resistance state in response to the incoming radio frequency signal not satisfying a defined threshold radio frequency high power level, to electrically decouple the metallic inner portion from the metallic outer portion, wherein, in the high resistance state, the metallic ring resonator section passes the incoming radio frequency signal to the radio frequency sensitive circuitry.

11. The metasurface of claim 10, wherein the metallic ring resonator section comprises a respective metallic ring resonator of an array of respective metallic ring resonators of the metasurface, and wherein the respective metallic ring resonators are configured to protect respective radio frequency sensitive devices of the radio frequency sensitive circuitry.

12. The metasurface of claim 10, wherein the defined threshold radio frequency high power level is based on at least one of: a length of the metal-insulator transition material, a width of the metal-insulator transition material, or a thickness of the metal-insulator transition material.

13. The metasurface of claim 10, wherein the metallic ring resonator section corresponds to a specific frequency range to pass through to the radio frequency-sensitive device when the metal-insulator transition material is in the high resistance state.

14. The metasurface of claim 10, wherein the metal-insulator transition material comprises vanadium dioxide.

15. The metasurface of claim 10, wherein the metallic inner portion comprises four respective sides, and wherein the metal-insulator transition material comprises four respective patches adjacent to the four respective sides.

16. The metasurface of claim 10, wherein the metallic ring resonator section and the metal-insulator transition material are fabricated as a single unit.

17. A system, comprising:
a metasurface that protects radio frequency circuitry from incoming electromagnetic waves that satisfy a defined threshold power level, the metasurface comprising:
a metallic inner portion;
a metallic outer portion; and
a metal-insulator transition material that transitions to a low resistance state in response to the defined threshold power level being satisfied, and transitions to a high resistance state in response to the defined threshold power level not being satisfied,
wherein the metal-insulator transition material separates the metallic inner portion from the metallic inner portion,
wherein, in the low resistance state, the metal-insulator transition material electrically couples the metallic inner portion to the metallic outer portion to prevent the incoming electromagnetic waves from passing through the metasurface to the radio frequency circuitry, and
wherein, in the high resistance state, the metal-insulator transition material electrically insulates the metallic inner portion from the metallic outer portion to allow the incoming electromagnetic waves to pass through the metasurface to the radio frequency circuitry.

18. The system of claim 17, wherein the metasurface corresponds to a specific frequency range to pass through to the radio frequency-sensitive device when the metal-insulator transition material is in the high resistance state.

19. The system of claim 17, wherein the metal-insulator transition material comprises vanadium dioxide.

20. The system of claim 17, wherein the metallic inner portion comprises four respective inner sides, wherein the metallic outer portion comprises four respective outer sides, and wherein the metal-insulator transition material comprises four respective patches between the four respective inner sides and the four respective outer sides.
